(19) United States
(12) Patent Application Publication
(10) Pub. No.: US 2026/0184392 A1
(43) Pub. Date: Jul. 2, 2026

(54) POWER CONVERSION SYSTEM FOR POWER MACHINES

(71) Applicant: Doosan Bobcat North America, Inc., West Fargo, ND (US)

(72) Inventors: Brent Durkin, Bismarck, ND (US); Andrew Hoffman, Bismarck, ND (US)

(21) Appl. No.: 19/431,374

(22) Filed: Dec. 23, 2025

Related U.S. Application Data
(60) Provisional application No. 63/739,197, filed on Dec. 27, 2024.

(51) Int. Cl. B62D 49/06; B60K 1/00; B60K 1/02; B60K 17/08; B60L 50/00; F16H 47/02

(52) U.S. Cl. CPC B62D 49/0671; B60K 1/00; B60K 1/02; B60K 17/08; B60L 50/00; F16H 47/02; B60L 2200/40

(57) ABSTRACT

A power machine can include a power machine frame, an electric power source supported by the power machine frame, an electric motor powered by the electric power source, and a hydrostatic transmission powered by the electric motor. The electric motor can power the hydrostatic transmission via a power transmission assembly that transfers power from the electric motor to the hydrostatic transmission at a reduced rotational speed.

### CROSS-REFERENCE TO RELATED APPLICATIONS

This application claims priority to U.S. Provisional Application No. 63/739,197, filed Dec. 27, 2024, the entirety of which is incorporated herein by reference.

### BACKGROUND

This disclosure is directed toward power machines. More particularly, this disclosure is directed towards systems of a power machine for power delivery, including for tractive, auxiliary, and external operations. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini loaders), excavators, utility vehicles, mowers, tractors (including compact tractors), and trenchers, to name a few examples.

Conventional power machines can include various systems and related components that are configured to use output from a power source (e.g., an electric motor) to perform different work functions. More specifically, the power source can transmit power to a power conversion system (e.g., a drive motor) to power a movement of a power machine or an implement or execute other operations.

The discussion above is merely provided for general background information and is not intended to be used as an aid in determining the scope of the claimed subject matter.

### SUMMARY

Power machines and related systems and methods as disclosed herein, including compact tractors in particular, can include different systems to improve functionality and structure of the machine. For example, among other improvements, different implementations can provide power machines with an improved arrangement of motors.

Some examples provide a power machine that includes a power machine frame, an electric power source supported by the power machine frame, an electric motor powered by the electric power source, a hydrostatic transmission powered by the electric motor, and a power transmission assembly. The power transmission assembly can be configured to transfer power from the electric motor to the hydrostatic transmission at a reduced rotational speed relative to a rotational speed of the electric motor, so that the electric motor powers the hydrostatic transmission at the reduced rotational speed via the power transmission assembly.

In some examples, the power transmission assembly can be a belt drive system. The belt drive system can include an upper pulley mounted on an input shaft of the power transmission assembly that is powered by the electric motor, a lower pulley mounted on an output shaft of the power transmission assembly that powers the hydrostatic transmission, and a belt encircling the upper pulley and the lower pulley. The power machine can further include a bracket that is supported on the power machine frame. The bracket can be positioned forward of the hydrostatic transmission and can support the power transmission assembly. The electric motor can be arranged on a rear side of the bracket.

In some examples, the power machine can further include a hydraulic pump connected to the power transmission assembly to receive power from the electric motor. The hydraulic pump can be operatively connected to the hydrostatic transmission to provide a charge flow to the hydrostatic transmission.

In some examples, the electric motor can be a primary motor, and the power machine can further include a secondary motor that is connected to the power transmission assembly to provide power to the hydrostatic transmission. The power machine can further include a secondary power source that provides power to the secondary motor.

In some examples, the power machine can be a tractor.

Some examples provide a drive system for a power machine. The drive system can include an electric motor configured to be powered by an electric power source of the power machine, a hydrostatic transmission including a hydrostatic drive pump configured to power travel of the power machine over terrain, and a power transmission assembly. The power transmission assembly can operatively couple the electric motor to the hydrostatic transmission to transmit power from the electric motor to the hydrostatic drive pump at a reduced rotational speed relative to a rotational speed of the electric motor.

In some examples, the power transmission assembly can include a belt drive system. The belt drive system can include an input pulley that includes an input shaft operatively coupled to the electric motor to be powered by the electric motor, an output pulley that includes an output shaft operatively coupled to the hydrostatic transmission to power the hydrostatic drive pump, and a belt configured to transmit power from the input pulley to the output pulley. The input pulley can be an upper pulley. The output pulley can be a lower pulley. The input pulley can have a smaller diameter than the output pulley. The output shaft can be configured to extend rearwardly to the hydrostatic transmission and the electric motor can be supported rearwardly of the input pulley.

In some examples, the drive system can further include a hydraulic charge pump operatively connected to an output of the power transmission assembly (e.g., the output pulley) to receive power from the electric motor, to provide a charge flow to the hydrostatic transmission. The hydraulic charge pump can be operatively connected to the output so as to be located on an opposite side of power transmission assembly from the hydrostatic transmission.

In some examples, the electric motor can be a primary motor, and the drive system can further include a secondary motor operatively connected to the power transmission assembly to provide power to the hydrostatic transmission. The secondary motor can be configured to be powered at a lower voltage than the primary motor.

Some examples provide a tractor that includes a tractor frame, an electric power source supported by the tractor frame, an electric motor supported by the tractor frame and configured to be powered by the electric power source, a hydrostatic transmission supported by the tractor frame, tractive elements configured to be powered by the hydrostatic transmission to convey the tractor over terrain, and a power transmission assembly supported by the tractor frame. The power transmission assembly can be configured to transfer power from the electric motor to the hydrostatic transmission to power the hydrostatic transmission with a smaller rotational speed at the hydrostatic transmission than provided by the electric motor.

In some examples, the power transmission assembly can include an input shaft configured to receive rotational power from the electric motor and an output shaft that is configured to provide rotational power to the hydrostatic transmission. The output shaft can be lower than the input shaft, relative to the tractor frame. The electric motor and the hydrostatic transmission can extend rearwardly from the power transmission assembly, relative to a front-to-back direction defined by the tractor frame.

This Summary and the Abstract are provided to introduce a selection of concepts in a simplified form that can be further described below in the Detailed Description. This Summary and the Abstract are not intended to identify key features or essential features of the claimed subject matter, nor are they intended to be used as an aid in determining the scope of the claimed subject matter.

### DRAWINGS

The following drawings are provided to help illustrate various features of non-limiting examples of the disclosure and are not intended to limit the scope of the disclosure or exclude alternative implementations.

FIG. 1 is a block diagram illustrating functional systems of a representative power machine on which examples of the present disclosure can be advantageously practiced.

FIG. 2 is a block diagram illustrating components of a power system of a compact tractor or other configuration of the power machine of FIG. 1.

FIG. 3 illustrates a side elevation, partly transparent view of a representative power machine in the form of a compact tractor.

FIG. 4 illustrates a side elevation, partly transparent view of the compact tractor of FIG. showing components of a power conversion system of the compact tractor.

FIG. 5 illustrates a side elevation view of the power conversion system of FIG. 4.

FIG. 6 illustrates a front elevation, partly transparent view of a power transfer assembly of the power conversion system of FIG. 4.

FIG. 7 illustrates a side elevation view of another configuration of the power transfer system of FIG. 6 according to aspects of the present disclosure.

### DETAILED DESCRIPTION

The concepts disclosed in this discussion are described and illustrated by referring to exemplary configurations. These concepts, however, are not limited in their application to the details of construction and the arrangement of components in the illustrative examples and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Conventional power machines can include a power conversion system that delivers power to operate tractive elements of the power machine or perform different work functions. Typically, a power source configured as an internal combustion engine is used to power pump assemblies, to transmit power for tractive or other operations.

In various contexts, however, it may be useful to electrify the powertrain by replacing an engine with an electric power source (e.g., an electric battery pack, capacitor assembly). Under conventional approaches, the engine is arranged within a cowling space of a power machine frame. However, arrangements for an engine and a hydrostatic transmission in conventional power machines may not be optimally suited for use with electrically powered power machines (e.g., using battery power). For example, the existing engine cowling space may not be optimal for powered actuators (e.g., electrical motors) powered by an electric power source. Further, in some cases, an operational characteristic of an electric motor (e.g., optimal or maximum rotational speed) may not match optimal operational characteristics of a hydrostatic transmission or other hydraulic system (e.g., an optimal or maximum rotational speed). For example, efficient operation of an electric motor may correspond to rotational speeds that exceed those recommended (or possible) for a pump or other components of a hydrostatic transmission. In this case and others, it may thus be desirable to provide improved utilization of space to accommodate an electric motor (e.g., as opposed to reconfiguring a power machine frame). Similarly, it may be desirable to provide power from the electric motor to a hydrostatic transmission at a desired (e.g., reduced) rotational speed.

Examples of the disclosed technology can provide improvements in this regard, and various others as further detailed below. In particular, some embodiments of the disclosed technology can provide configurations of electric motors and associated support structures that allow more efficient use of electric power to replace an engine, including to power a hydrostatic transmission or other elements for a compact tractor.

In some embodiments, intermediary power transmissions components can be provided between an electric motor and one or more drive axles to transfer power from the electric motor to downstream systems. In some cases, the intermediary components can include a power transmission assembly that can modify input rotational power from a drive motor so that output rotational power is provided with a different (e.g., reduced) rotational speed than the input rotational power. In different examples, a variety of different transmission assemblies can be used in this regard, including belt-driven or other pulley systems, gear systems, or other arrangements known in the art. In some examples, a power transmission assembly can include a speed-reducing belt drive arranged to transfer rotational power from an electric motor to a hydrostatic transmission (e.g., a hydraulic drive pump in hydraulic communication with a hydraulic drive motor) or can include a different speed-adjusting (e.g., speed-reducing) assembly. Accordingly, power from an electric motor can be transferred by the belt drive to a hydraulic system (e.g., to a hydrostatic drive pump) within an optimal rotational speed range for the hydraulic system (e.g., at reduced speeds relative to optimal or other run-time rotating speeds of the electric motor).

In some cases, power transmission assemblies can allow the electric motor to be arranged within a pre-existing engine cowling space (e.g., above a corresponding pump and other transmission components). Correspondingly, using power transmission assemblies, such as a belt drive, can allow for a compact arrangement of powertrain elements within a power machine frame and allow other components (e.g., an on-board power storage) to fit within the power machine frame as well. In some embodiments, an additional motor can be additionally (or alternatively) engaged with the belt drive to selectively power transmissions or pumps.

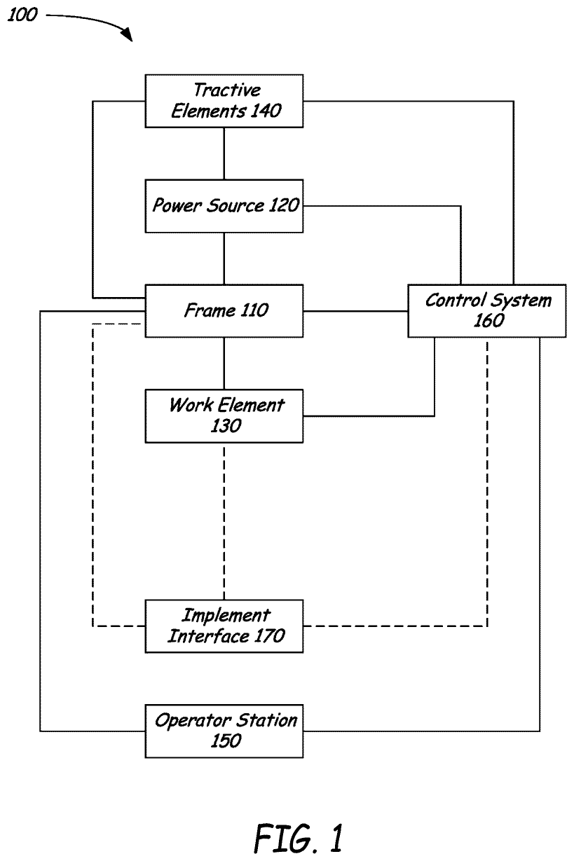

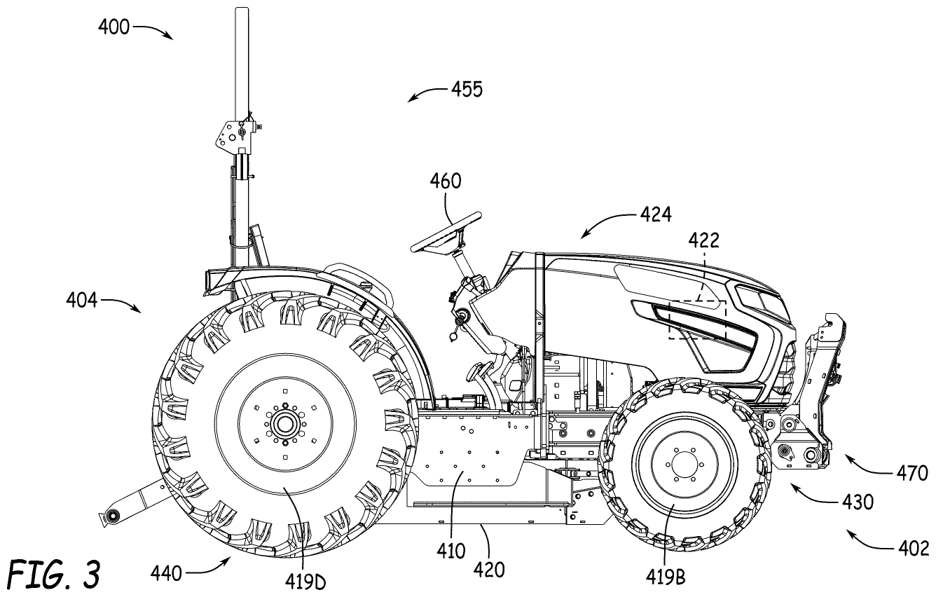

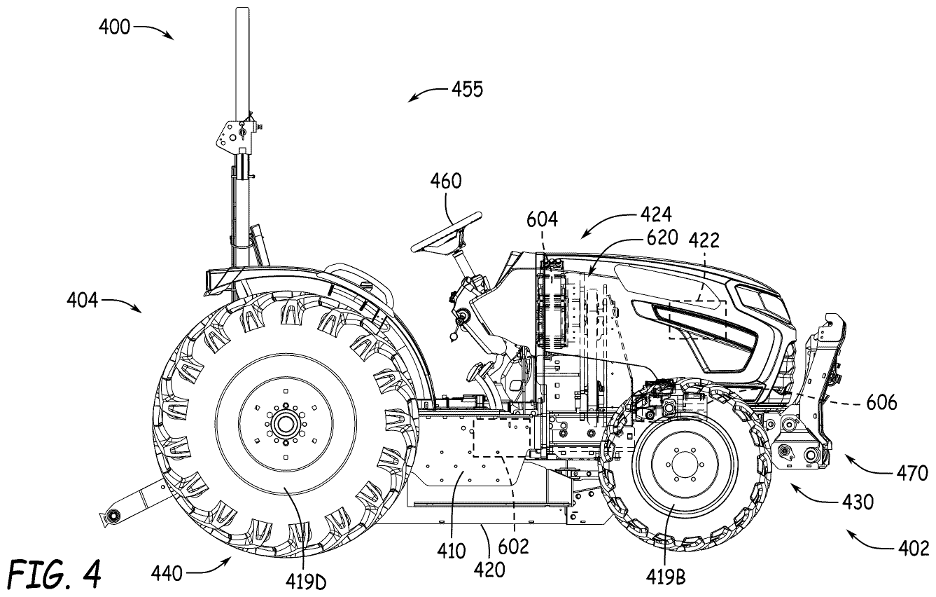

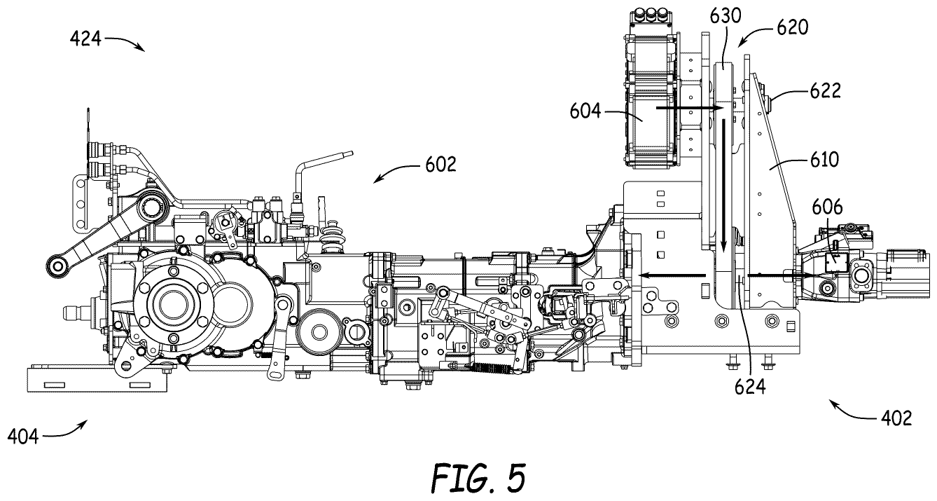

These concepts can be practiced on various power machines, as will be described below. Representative configurations of power machines on which the examples of the disclosed technology can be practiced are illustrated in diagram form in FIGS. 1-3, and generally illustrated in FIGS. 4 and 5. For the sake of brevity, only one power machine is illustrated and discussed as being a representative power machine. However, as mentioned above, the examples below can be practiced on any of a number of power machines, including power machines of different types from the representative power machine shown in FIGS. 3-4. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram that illustrates the basic systems of a power machine 100, which can be any of a number of different types of power machines upon which the examples discussed below can be advantageously incorporated. The block diagram of FIG. 1 both identifies various systems on power machine 100 and shows relationships between various components and systems. At the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to selectively move the power machine over a support surface. The power machine also includes an operator station 150 that provides an operating position where an operator can manipulate operator inputs for controlling the work elements of the power machine (e.g., a cab, an open station with an operator seat or standing pad, etc.).

A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations. For example, the control system 160 can include one or more general or special-purpose electronic computers of various generally known designs. According to some examples, the control system 160 can include a hydraulic circuit provided to interact with other systems to perform various work tasks at least in part in response to signals given by an operator by way of movement of input devices arranged on the power machine 100 (e.g., within the operator station 150). Generally, the control system 160 can include or be in communication with various input devices, including operator input devices (e.g., joysticks, pedals, touchscreens, etc.), sensors distributed on or around the power machine 100, or output ports for various other components (e.g., electronic output ports of electric motors or other equipment).

Certain work vehicles have work elements 130 that can perform a dedicated task. For example, some work vehicles have a lift arm to which various implements can be attached by a pinning or other arrangement (e.g., buckets, grapples, mower decks, etc.). A lift arm, as a form of a work element, can be manipulated by various actuators to position an implement to perform a task.

Some power machines may include removable work elements, including as can be in the form of a wide variety of implements that can be attached to the power machine frame 110 via an implement interface 170. At its most basic, the implement interface 170 is a connection mechanism between the frame 110 or a work element 130 and an implement, which can be as simple as a pivoting or other connection point for attaching an implement directly to the frame 110 (or another work element 130) or can include more complex arrangements, including implement carriers.

On some power machines, the implement interface 170 can include, as an implement carrier, a physical structure movably attached to a work element (e.g., lift arm) and removably attachable to one or more implements. In this regard, the implement carrier can have engagement features and locking features to accept and secure any of a number of different implements to the work element. In some implementations, once an implement is attached to an implement carrier, the implement is fixed relative to the implement carrier so that when the implement carrier is moved with respect to the frame 110, the implement moves with the implement carrier. (The term implement carrier as used herein is not merely a pivotal connection point, but rather a dedicated device specifically intended to accept and be secured to various different implements.) An implement carrier can be mountable to a work element 130 such as a lift arm, or to the frame 110. The implement interface 170 can also include one or more power sources for providing power to one or more work elements on an implement.

Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles, including some compact tractors, have articulated frames such that one portion of the frame pivots with respect to another portion for accomplishing at least a portion of the machine movement related to steering functions.

Frame 110 supports the power source 120, which is configured to provide power to one or more work elements 130 including the one or more tractive elements 140, as well as, in some instances, providing power for use by an operably coupled implement via implement interface 170 (e.g., via one or more hydraulic connections on or near the implement interface 170). Power from the power source 120 can be provided directly to any of the work elements 130, tractive elements 140, and implement interfaces 170. Alternatively, power from the power source 120 can be provided to a control system 160, which in turn selectively provides power to the elements that are capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electric sources or a combination of different types of power sources (e.g., electric power sources and engines), known generally as hybrid power sources.

FIG. 1 shows a single work element designated as work element 130, but various power machines can have any number of work elements. Work elements are typically attached to the frame of the power machine and movable with respect to the frame when performing a work task. In some examples, as also discussed above, work elements can include lift arm assemblies. In some examples, work elements can include mower decks or other similar equipment. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame. In contrast, workgroup work elements are configured to implement non-drive operations (e.g., moving or otherwise operating various implements).

Power machine 100 includes an operator station 150 that includes an operating position from which an operator can control operation of the power machine. In some power machines, the operator station 150 is defined by an enclosed or partially enclosed cab. Some power machines on which the disclosed technology may be practiced may not have a cab or an operator compartment of the type described above. For example, a walk behind loader may not have a cab or an operator compartment, but rather an operating position that serves as an operator station from which the power machine is properly operated. As another example, many compact tractors do not have a cab to enclose its operator station. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both of the power machine and any implement to which is it coupled) that is capable of controlling at least some of the operator-controlled functions on the power machine.

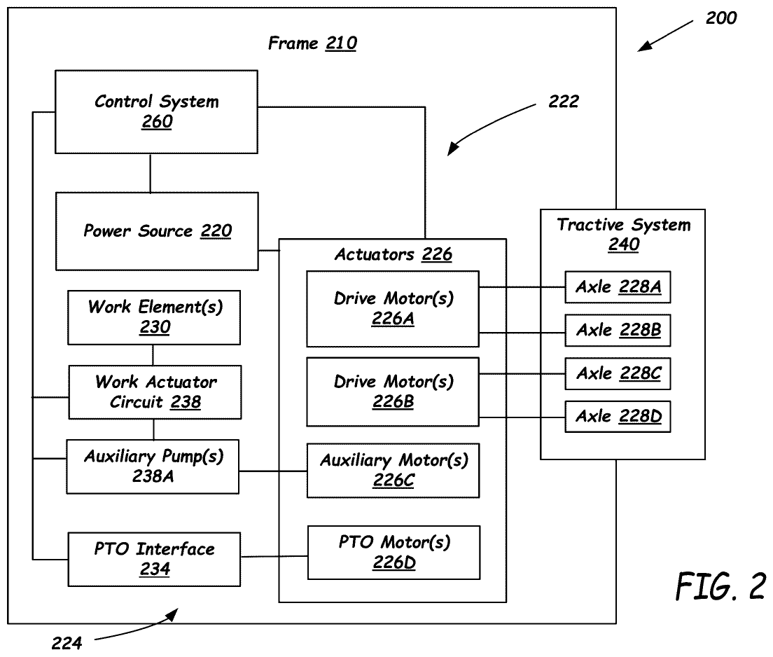

FIG. 2 illustrates an example of an electrically powered compact tractor 200, which is one particular example of the power machine 100 illustrated in FIG. 1. To that end, features of the tractor 200 described below include reference numbers that are generally similar to those used in FIG. 1. For example, the tractor 200 has a frame 210, just as power machine 100 has a frame 110. In particular, the frame 210 can be a tractor frame, configured to support tractive elements configured as relatively large (e.g., non-steerable) rear wheels, relatively small (e.g., steerable) front wheels, and to support a power source at a front portion of the frame (e.g., aligned with the front wheels).

Particular implementations may be particularly suited for power machines configured as tractors, and the tractor 200 is thus described herein to provide a reference for understanding one environment on which the examples described below related to hydraulic drive and auxiliary hydraulic control systems and methods may be practiced. However, the tractor 200 should not be considered limiting especially as to the description of features that tractor 200 may have described herein that are not essential to the disclosed examples and thus may or may not be included in power machines other than the tractor 200 upon which the examples disclosed below may be advantageously practiced. Unless specifically noted otherwise, examples disclosed below can be practiced on a variety of power machines, with the tractor 200 being only one of those power machines. For example, some or all of the concepts discussed below can be practiced on many other types of work vehicles such as various other loaders, excavators, trenchers, and dozers, to name but a few examples.

The frame 210 of the tractor 200 supports a power source 222 that can generate or otherwise provide power for operating various functions on the power machine. For example, the power source 222 can include an electric power source 220 configured to supply electric power for power machine operations (e.g., a battery assembly, a generator, a capacitor system, etc.), as well as a power conversion system 224 arranged to utilize the power from the power source 220 for useful power machine operations.

In different examples, the power conversion system 224 of the tractor 200 can include various components, including mechanical transmissions, hydraulic systems, various motors or other actuators, and the like. In some examples, the power conversion system 224 of the tractor 200 includes one or more electric drive motors 226A, 226B, which can be powered by the power source 220 and can be selectively controllable (e.g., via the control system 260) to provide a power to drive axles 228A-228D or other tractive assemblies of a tractive system 240. In some examples, as further discussed below, a first drive motor 226A can power a first set of axles (e.g., axles 228A, 228B) and a second drive motor 226B can power a second set of axles (e.g., axles 228C, 228D) that are connected to corresponding tractive elements (e.g., wheels or tracks, not shown in FIG. 2). However, other configurations are possible, including with a respective dedicated motor for each axle, with only front or only rear axles being powered, and so on.

In some examples, the power conversion system 224 can be differently arranged, including with different arrangements of actuators. For example, as shown in inset in FIG. 2, the actuators 226 can include an electric drive motor 226D that is powered by the power source 220 to provide power to a hydraulic drive component (e.g., a hydrostatic drive pump 226E of a hydrostatic drive system, which may in turn power a hydrostatic motor (not shown) to power travel over terrain).

The power conversion system 224 of tractor 200 also includes an auxiliary motor 226C that can be powered by the power source 220 and controlled by the control system 260 to provide rotational power to one or more corresponding auxiliary pumps 238A. The auxiliary pumps 238A can thus be operated, using electric power from the power source 220, to provide hydraulic flow for various power machine functions. In particular, for example, the auxiliary pump(s) 238A may provide hydraulic flow to a work actuator circuit 238 that can be configured to operate a lift arm, implement, or other work element 230 (e.g., using various known hydraulic valves, actuators, controllers, and so on).

In some cases, the actuators 226 of the power conversion system 224 can include one or more power take-off (PTO) motors 226D. For example, the PTO motor(s) 226D can be operated using power from the power source 220, as controlled by the control system 260, to provide rotational power to an output shaft or other form of PTO interface 234. For example, a belt-driven or other power transfer system (e.g., a chain drive system, a rope drive system, a gear drive system, a slew drive system, etc.) can be provided to transmit rotational power from the PTO motor 226D to the PTO interface 234.

FIGS. 3 and 4 illustrate an example compact tractor 400, which is one particular example of the power machine 100 of FIG. 1 or the tractor 200 of FIG. 2, where the examples discussed below can be advantageously employed. To that end, features of the tractor 400 described below include reference numbers that are generally similar to those used in FIGS. 1 and 2 and discussion of above applies to similar numbers below unless otherwise noted or required. For example, the tractor 400 is described as having a frame 410 (e.g., a tractor frame), just as power machine 100 has a frame 110. However, the tractor 400 as illustrated should not be considered limiting, and examples disclosed below can also be practiced on a variety of other power machines including loaders.

The frame 410 of the tractor 400 supports a power source 420 that is capable of generating or otherwise providing power for operating various functions on the power machine. In particular, the power source 420 can include an electric power source in some examples, e.g., configured in particular as a battery assembly as in the illustrated example, or other electrical power source (e.g., capacitor bank, generator, fuel cell, etc.). As shown, the power source 420 can be located at least partly external to the frame 410 and can be a support for powered movement to and from an installed orientation (e.g., to swap the power source 420 for another, as further detailed below). In the illustrated example, in particular, the power source 420 extends below a bottom of the frame 410. In other examples, however, the power source 420 can be differently located, including at locations partly or fully internal to the frame 410 (e.g., within a battery bay accessed from the bottom of the frame 410).

In some configurations, one or more other power sources can be provided on the tractor 400. For example, the tractor 400 can include a secondary power source 422 that is an on-board battery (or another electrical power source). In some cases, the secondary power source 422 can supply power to the tractor 400 during swapping of the power source 420 with a replacement power source (e.g., to replace a depleted battery assembly with a charged battery assembly). For example, the secondary power source 422 can be sized to allow limited-range or limited-speed travel of the tractor 400 and to allow operation of a support assembly to dock or undock the power source 420 (e.g., as a modular assembly) from the tractor 400. While the illustrated example includes the secondary power source 422 at a front end 402, the secondary power source 422 can be provided at a rear end 404 in other examples, or at other locations.

In particular, the frame 410 is shown supported by front wheels 419A, 419B (wheel 419A hidden from view in FIGS. 3 and 4) and rear wheels 419C, 419D (wheel 419C hidden from view in FIGS. 3 and 4). In other examples, articulated frames can be used, such that a front frame portion can be moved along one or more degrees of freedom (e.g., pivoted about a vertical or a horizontal axis) relative to a rear frame portion. Further, other ground-engaging elements can be used in other examples. Generally, a traction system 440 that includes the wheels or other ground-engaging elements can be powered by the power source, as can a lift arm assembly 430 or other work elements. In some examples, an implement interface 470 (or other sub-system) can include power couplers that can transmit power from the power source 420 to an attached implement (not shown) or vice versa. In some examples, a PTO interface can be provided (e.g., a pully-operated output shaft).

The tractor 400 includes an operator station 455 from which an operator can manipulate various control devices 460 to cause the power machine to perform various work functions. In the illustrated example, the control devices 460 can be configured in particular to control operation of a power conversion system 424 or various support assemblies (e.g., a support assembly for docking the power source 420).

With specific reference to FIG. 4, the power conversion system 424 can be arranged to utilize the power from the power source 420 for useful power machine operations. In particular, the power conversion system 424 can include various components, including mechanical or hydraulic transmissions, other hydraulic systems (e.g., various motors or other actuators), and the like. For example, the power conversion system 424 can include a primary motor 604 that drives a transmission 602 (e.g., a hydrostatic transmission, with both mechanical and hydraulic transmission components). The transmission 602 can in turn transfer power from the primary motor 604 to operate the tractive system 440 (e.g., via a dedicated hydrostatic circuit). In some cases, the primary motor 604 can be an electric motor, e.g., an axial flux motor.

In some embodiments, the primary motor 604 and the transmission 602 can optimally operate at different rotational speeds or rotational power. For example, the primary motor 604 can operate at relatively high speeds (e.g., about 4000 rpm) or provide relatively high power (e.g., about 90 horsepower), and the transmission 602 can operate at relatively low speeds or require relatively low power (e.g., about 40 horsepower), corresponding to optimal speeds for operation of a hydrostatic drive pump of the transmission 602 or otherwise. As such, because electric motors (e.g., the primary motor 604) are typically configured to optimally operate at high speeds, one or more intermediary power transmission components may be installed to transfer power between a motor and one or more drive axles, to alter the output speed or the output torque provided by the electric motor to the drive axle (e.g., to reduce speed or torque).

Thus, for example, by transferring power at a reduced rotational speed, the disclosed power transmission assembly may allow a hydrostatic transmission to operate within its optimal speed range, which may reduce wear on transmission components, improve hydraulic efficiency, and extend the operational lifespan of the hydrostatic drive pump. Further, such intermediary components for speed reduction can sometimes also result in increased operational efficiency of the electric motors themselves (e.g., by allowing operation of those motors at optimal speeds, regardless of mismatch with optimal speeds for other components powered by the motors).

Accordingly, the power conversion system 420 can further include one or more speed-adjusting assemblies (i.e., one or more assemblies configured to operate mechanically or otherwise to modify a received rotational speed of rotational power and thus provide a different output rotational speed). As a reduction assembly, for example, such a speed-adjusting assembly can be arranged to transmit power between a motor and another powered component (e.g., an input to a hydrostatic drive pump of the transmission 602), while reducing the corresponding rotational speed.

Generally, the power conversion system 420 can include a variety of known configurations of reduction assemblies, including systems of meshed gears, belt drives, chain drives, etc. However, in some cases, use of a belt drive can provide particularly favorable spatial arrangements, speed reduction, and other characteristics. For example, FIGS. 5-7 illustrate a power transmission assembly 620 of the power conversion system 424, which can indirectly couple the primary motor 604 to the transmission 602. As shown, the power transmission assembly 620 can include a belt drive (e.g., a pulley assembly) to transmit power from the primary motor 604 to the transmission 602. Although other configurations are possible, such a belt drive system in particular may provide useful vibration dampening between the electric motor and the hydrostatic transmission, which may reduce noise and mechanical stress on connected components. Additionally, as compared to other systems, belt drives may be able to more readily accommodate slight misalignment between shafts (e.g., due to manufacturing tolerances), thus simplifying installation and upstream manufacturing processes.

A shown in FIGS. 5-7 and further discussed below, a belt drive (or other power transmission assembly) can be arranged vertically (i.e., to transmit power between vertically offset rotational axes). Correspondingly, for example, the belt drive can extend upward relative to (and from) the transmission 602, to better utilize available space within the frame 410. In particular, the vertical arrangement of upper and lower pulleys (e.g., as discussed below) may help to reduce the overall footprint of the power conversion system and free up space within (or on) the frame for other components, e.g., battery assemblies or auxiliary systems. This approach may also advantageously locate input motors relative to other components (e.g., with spacing that provides ease of access, improved cooling, etc.).

In some cases, a bracket 610 can support the power transmission assembly 620 and be secured to the transmission 602. For example, the primary motor 604 can be supported on the bracket 610 and be coupled to the power transmission assembly 620 via an input shaft 622 (e.g., as shown, that extends from the motor 604 past a corresponding belt 630 or other power flexible power transmission member). The transmission 602, shown with side portions partially removed in FIG. 5 to illustrate internal components, can be mounted to the bracket 610 (e.g., to extend rearward thereof) and be coupled to the power transmission assembly 620 via an output shaft 624 (e.g., connected via a flex coupler or a flywheel). Or, in other cases, other mounting arrangements can be used (e.g., with the bracket 610 and the transmission 602 separately supported by a power machine frame).

In particular, the bracket may provide a rigid mounting interface that maintains appropriate alignment between the electric motor and the hydrostatic transmission, which may help to ensure consistent belt tension and reduce the likelihood of belt slippage or premature wear. Further, in particular, the bracket 610 or other arrangements can allow an electric motor to be positioned relatively rearwardly (e.g., mounted on a rear side) of the bracket, which may facilitate access for maintenance and improve overall efficiency in use of available space (e.g., relative to the hydrostatic transmission and other components).

In some cases, the input shaft 622 and the output shaft 624 can be offset by a predetermined distance. In some cases, the distance between the input shaft 622 and the output shaft 624 can be determined based on the particular belt or type of the belt 630 for the power transmission assembly 620 (e.g., V belt, multi-V belt, cogged belt, etc.) and a corresponding length of the belt 630. In the illustrated example, the primary motor 604 extends horizontally rearward of the bracket 610 toward the rear end 404, as does the (e.g., hydrostatic) transmission 602. Although this rearward extension of the motor 604 and parallel rearward extension with the transmission 602 may be particularly beneficial for packaging in some cases (e.g., to accommodate other power components as discussed below), other configurations are possible in other cases. For example, the primary motor 604 can be arranged forward of the bracket 610, above the bracket 610, or otherwise differently positioned.

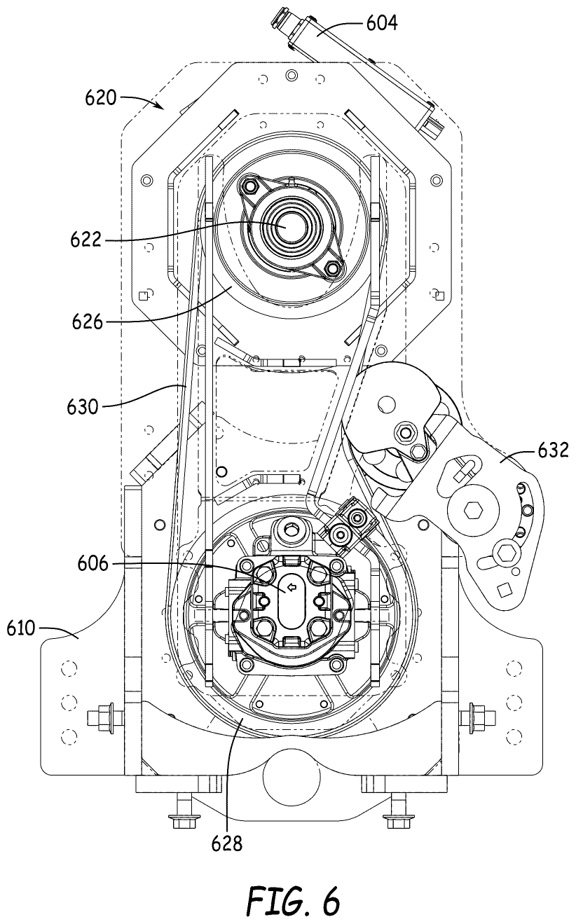

In particular examples, the power transmission assembly 620 can transmit power from the motor 604 at a desired reduced speed via a pulley system. In the illustrated example, as shown in FIG. 6 in particular, the power transmission assembly 620 includes an upper input pulley 626 and a lower output pulley 628 that support the belt 630, although other arrangements of input and output pulleys (or other transmission elements) are possible. The input shaft 622 can engage and rotate with the upper pulley 626, and the output shaft 624 can engage and rotate with the lower pulley 628. In some examples, a diameter of the upper pulley 626 can be smaller than a diameter of the lower pulley 628. Accordingly, as the belt 630 rotates on the upper pulley 626 and the lower pulley 628, the output shaft 624 can rotate at a reduced speed and produce a higher torque relative to the input shaft 622.

In some cases, an idler 632 (e.g., as shown in FIG. 6) can be provided to provide spring tension to the belt 630. In some cases, the idler 632 can adjust various aspects of the configuration of the power transmission assembly 620. For example, the idler 632 can adjust an amount of spring tension to the belt 630 or adjust a path for the belt 630 for packaging or other purposes. In this regard, the idler 632 or other tension adjustment device can also allow for selective reduction of power transmission (e.g., to avoid overloading the transmission 602). In some cases, the belt 630 can be a stretch-fit belt that provides a desired amount of tension to the pully system without a need for an idler (e.g., the idler 632).

In some cases, the belt 630 may need to be replaced, for example, when the belt 630 wears out over time or breaks due to a relatively high input force. Correspondingly, however, the belt 630 can operate as a fuse between the primary motor 604 and the transmission 602 by interrupting the power transmission in the event of excess torque (etc.) to prevent potential damage to other transmission components. By interrupting power transmission in the event of excess torque, for example, the belt may help to protect more expensive or difficult-to-replace components such as the hydrostatic drive pump or the electric motor from damage.

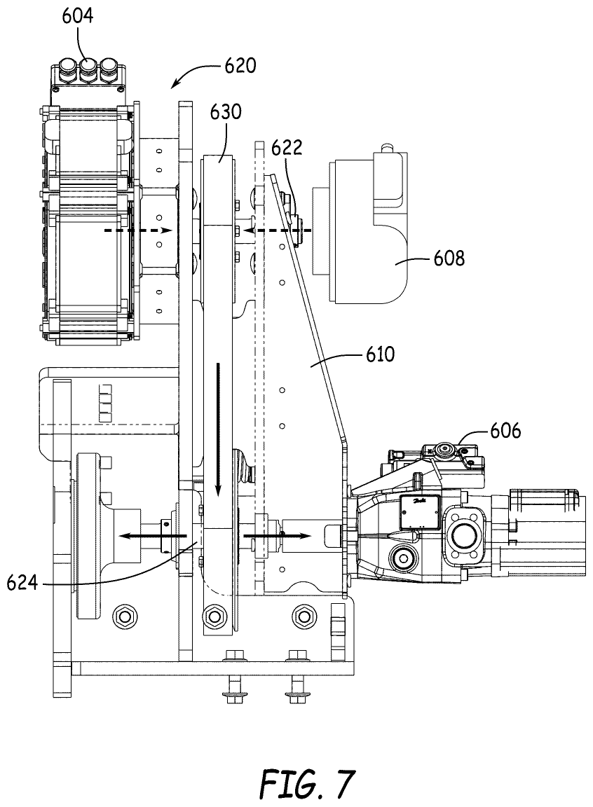

In some embodiments, the power conversion system 424 can be configured to divide power transmission from the motor 604 to multiple power sinks. For example, in some embodiments, the power conversion system 424 can include a hydraulic pump 606 to provide hydraulic fluids for various operations of the compact tractor 400. The hydraulic pump 606 can be connected to the output shaft 624—and thus to the lower pulley 628—or otherwise arranged to receive power in parallel with (or instead of) the transmission 602, with corresponding division of power from the motor 604. For example, the hydraulic pump 606 can also be arranged to be driven by the shaft 624, on an opposite end of the shaft from the transmission 602 (and, correspondingly, spaced in an opposite direction from the pulley 628 than is the transmission 602). Thus for example, the hydraulic pump 606 can operate at the same rotational speed as the transmission 602 in some implementations, with power from the motor 604 divided at the pulley 628 (e.g., as illustrated by arrows in FIGS. 5 and 7).

Accordingly, the configuration of the power transmission assembly 620 can allow flexibility to add pumps or driven components (e.g., via additional belts) while maintaining the existing architecture of the power conversion system 424. For example, additional components can be incorporated without a need to add an additional set of AC compressors or pumps. Due to the connection of the hydraulic pump to the output shaft of the power transmission assembly, for example, a single electric motor (or single combination of motors) may power both the hydrostatic transmission and the hydraulic pump, which may reduce the number of motors required for some arrangements, generally simplify electrical power and control systems, or reduce overall weight and cost, among other benefits. Further, operation of the hydraulic pump via the power conversion system 424 may provide benefits similar to those discussed above relative to hydrostatic transmissions (e.g., to allow operation at optimal pump speeds).

In the illustrated example, the hydraulic pump 606 is a stacked gear pump, although other configurations are possible. In some cases, separate pump sections of the hydraulic pump 606 can be dedicated to different sets of functionalities for the compact tractor 400. For example, a first section of the hydraulic pump 606 can provide hydraulic flow for steering of the compact tractor 400, and a second section of the hydraulic pump 606 can provide hydraulic flow for a PTO device or various auxiliary operations. In some cases, the hydraulic pump 606 can additionally (or alternatively) provide a charge flow to replenish components or hydraulic circuits of the transmission 602 (e.g., via an oil transmission line (not shown) leading from the pump 606 to the transmission 602). In some cases, the hydraulic pump 606 can be a piston pump, an auxiliary pump, an oil pump, or other types of pumps known in the art.

As a further example, the disclosed power transmission systems can additionally (or alternatively) allow easy addition or substitution of sources of input power. For example, with specific reference to FIG. 7, a secondary motor 608 can be provided on the input shaft 622 for additional or alternative power input, as compared to the motor 604. In the illustrated example, the secondary motor 608 is arranged at an opposite end of the input shaft 622 from the primary motor 604, which may be facilitated by the packaging arrangement generally discussed above and correspond to significant flexibility for attachment of various components (e.g., instead of the motor 608). As illustrated by the arrows in FIG. 7, the secondary motor 608 can provide power to the transmission 602 and the hydraulic pump 606, in parallel with the primary motor 604, or as an alternate power source (e.g., while the primary motor 604 is not operating). Thus, for example, a secondary motor may provide operational redundancy, allowing continued operation of the hydrostatic transmission in the event of a failure or selective disablement (e.g., de-rating or de-powering) of the primary motor or of the primary power source. Correspondingly, a parallel arrangement of motors as disclosed may ease service operations, while also improving reliability and reducing downtime during work operations.

In some cases, the secondary motor 608 can operate at a different voltage than the primary motor 604. For example, operating a secondary motor at a lower voltage than a primary motor may allow the secondary motor to be powered by a smaller, on-board battery that remains installed during maintenance on (e.g., swapping of) a main power source. This may enable continuous operation of essential functions during power source replacement, reducing interruption to work tasks. Thus, for example, the primary motor 604 can be configured to operate with power from a main electric power source at a first, higher voltage (e.g., the power source 420 in FIG. 4) and the secondary motor 608 can be configured to operate with power from the power source 422 at a second, lower voltage. Correspondingly, the tractor 400 can be flexibly operated with power from the power source 420 or different power sources (e.g., the power source 422) as needed—e.g., during operations powered by the power source 422 and the secondary motor 608 to swap the power source 420 for a more fully-charged replacement. In some cases, the primary motor 604 and the secondary motor 608 can rotate in opposite directions.

Accordingly, configuration of the power conversion system 424 to selectively accommodate the secondary motor 608 can beneficially allow switching between one or more operational voltages from one or more power sources. Further, in some cases, the ability to easily introduce the secondary motor 608 can allow flexibility in a more continuous operation of the transmission 602 by providing an additional power path for the transmission 602.

Although the presently disclosed technology has been described by referring preferred examples, workers skilled in the art will recognize that changes may be made in form and detail without departing from the scope of the discussion. In this regard, details presented relative to any of the examples discussed herein can be implemented independently or in various combinations.

As used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right-side wall of the cab, relative to a frame of reference of an operator who is within the cab and is oriented to operatively engage with controls of an operator station of the cab.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

As used herein, unless otherwise defined or limited, the terms “inboard” and “outboard” refer to a relative relationship (e.g., a lateral distance) between one or more objects or structures and a centerline of the power machine. For example, a first structure that is inboard of a second structure is positioned laterally offset from the second structure so that a distance between the first structure and the centerline of the power machine is less than a distance between the second structure and the centerline of the power machine. Conversely, a first structure that is outboard of a second structure is positioned laterally offset from the second structure so that a distance between the first structure and the centerline of the power machine is greater than a distance between the second structure and the centerline of the power machine.

Similarly, as used herein, unless otherwise defined or limited, the terms “interior” and “exterior” refers to a relative relationship (e.g., a lateral distance) between one or more structures (e.g., a sub-structure) and a centerline of a reference structure (e.g., a main structure) that extends in a front-to-back direction or between first and second ends of the reference structure. For example, an interior structure is disposed closer to a centerline of a reference structure than an exterior structure. In this regard, an outboard structure of a subassembly of a power machine may also be an exterior structure. In contrast, an exterior structure of a subassembly, relative to a centerline of the subassembly, may not necessarily be outboard of other components of the subassembly.

Also as used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

Some methods of the disclosed technology may be presented herein with operations in a particular order. Unless otherwise required or specified, the operations of such methods can be implemented in different orders, in parallel, or as selected sub-sets of one or more individual operations (e.g., with a particular operation being implemented alone, rather than in combination with other operations of the example).

Some methods of the disclosed technology may be presented above or below with operations listed in a particular order. Unless otherwise required or specified, the operations of such methods can be implemented in different orders, in parallel, or as selected sub-sets of one or more individual operations (e.g., with a particular listed operation being implemented alone, rather than in combination with others).

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically or operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include or utilize a control device (or controller) such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosed technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

1. A power machine comprising:
a power machine frame;
an electric power source supported by the power machine frame;
an electric motor powered by the electric power source;
a hydrostatic transmission powered by the electric motor; and
a power transmission assembly configured to transfer power from the electric motor to the hydrostatic transmission at a reduced rotational speed relative to a rotational speed of the electric motor, so that the electric motor powers the hydrostatic transmission at the reduced rotational speed via the power transmission assembly.

2. The power machine of claim 1, wherein the power transmission assembly is a belt drive system, the belt drive system comprising:
an upper pulley mounted on an input shaft of the power transmission assembly that is powered by the electric motor;
a lower pulley mounted on an output shaft of the power transmission assembly that powers the hydrostatic transmission; and
a belt encircling the upper pulley and the lower pulley.

3. The power machine of claim 2, further comprising a bracket that is supported on the power machine frame, the bracket being positioned forward of the hydrostatic transmission and supporting the power transmission assembly.

4. The power machine of claim 3, wherein the electric motor is arranged on a rear side of the bracket.

5. The power machine of claim 1, further comprising a hydraulic pump connected to the power transmission assembly to receive power from the electric motor.

6. The power machine of claim 5, wherein the hydraulic pump is operatively connected to the hydrostatic transmission to provide a charge flow to the hydrostatic transmission.

7. The power machine of claim 1, wherein the electric motor is a primary motor, and the power machine further includes a secondary motor that is connected to the power transmission assembly to provide power to the hydrostatic transmission.

8. The power machine of claim 7, further comprising a secondary power source that provides power to the secondary motor.

9. The power machine of claim 1, wherein the power machine is a tractor.

10. A drive system for a power machine, the drive system comprising:
an electric motor configured to be powered by an electric power source of the power machine;
a hydrostatic transmission including a hydrostatic drive pump configured to power travel of the power machine over terrain; and
a power transmission assembly operatively coupling the electric motor to the hydrostatic transmission to transmit power from the electric motor to the hydrostatic drive pump at a reduced rotational speed relative to a rotational speed of the electric motor.

11. The drive system of claim 10, wherein the power transmission assembly includes a belt drive system.

12. The drive system of claim 11, wherein the belt drive system includes:
an input pulley that includes an input shaft operatively coupled to the electric motor to be powered by the electric motor;
an output pulley that includes an output shaft operatively coupled to the hydrostatic transmission to power the hydrostatic drive pump; and
a belt configured to transmit power from the input pulley to the output pulley.

13. The drive system of claim 12, wherein the input pulley is an upper pulley, the output pulley is a lower pulley, and the input pulley has a smaller diameter than the output pulley.

14. The drive system of claim 13, wherein the output shaft is configured to extend rearwardly to the hydrostatic transmission and the electric motor is supported rearwardly of the input pulley.

15. The drive system of claim 10, further comprising a hydraulic charge pump configured to provide a charge flow to the hydrostatic transmission and operatively connected to an output of the power transmission assembly, to receive power from the electric motor to provide the charge flow.

16. The drive system of claim 15, wherein the hydraulic charge pump is operatively connected to the output so as to be located on an opposite side of power transmission assembly from the hydrostatic transmission.

17. The drive system of claim 10, wherein the electric motor is a primary motor, and the drive system further includes a secondary motor that is operatively connected to the power transmission assembly to provide power to the hydrostatic transmission.

18. The drive system of claim 17, wherein the secondary motor is configured to be powered at a lower voltage than the primary motor.

19. A tractor comprising:
a tractor frame;
an electric power source supported by the tractor frame;
an electric motor supported by the tractor frame and configured to be powered by the electric power source;
a hydrostatic transmission supported by the tractor frame;
tractive elements configured to be powered by the hydrostatic transmission to convey the tractor over terrain; and
a power transmission assembly supported by the tractor frame and configured to transfer power from the electric motor to the hydrostatic transmission to power the hydrostatic transmission with a smaller rotational speed at the hydrostatic transmission than provided by the electric motor.

20. The tractor of claim 19, wherein the power transmission assembly includes an input shaft configured to receive rotational power from the electric motor and an output shaft that is configured to provide rotational power to the hydrostatic transmission;
wherein the output shaft is lower than the input shaft, relative to the tractor frame; and
wherein the electric motor and the hydrostatic transmission extend rearwardly from the power transmission assembly, relative to a front-to-back direction defined by the tractor frame.
